(19) United States
(12) Patent Application Publication
(10) Pub. No.: US 2026/0196060 A1
(43) Pub. Date: Jul. 9, 2026

(54) LANE BOUNDARY ESTIMATION

(71) Applicant: QUALCOMM Incorporated, San Diego, CA (US)

(72) Inventors: Markus Petersson, LINKÖPING (SE); Adam Aili, Hallsberg (SE); Lukas Lorentzon, Linghem (SE); Joel Karl Mikael Fåk, Linköping (SE)

(21) Appl. No.: 19/012,396

(22) Filed: Jan. 7, 2025

(51) Int. Cl. G06V 20/56; B60W 30/12; B60W 30/18; B60W 40/072; B60W 50/14; G06T 3/4007; G06T 7/13

(52) U.S. Cl. CPC G06V 20/588; B60W 30/12; B60W 30/18163; B60W 40/072; B60W 50/14; G06T 3/4007; G06T 7/13

(57) ABSTRACT

A method for lane boundary estimation, the method comprising: obtaining, by one or more processors, a set of points corresponding to a lane boundary; computing, by the one or more processors, a plurality of lane boundary representations using at least a subset of the points; selecting, by the one or more processors, a lane boundary representation from the plurality of lane boundary representations that requires a smallest number of points while maintaining accuracy within a predetermined threshold; and outputting, by the one or more processors, the selected lane boundary representation.

### BACKGROUND

Various methods exist for detecting lane and road boundaries. Traditional techniques often involve edge detection in images, followed by fitting the detected edges to a curve, such as a polynomial or spline. Modern methods may utilize convolutional neural networks (CNNs) to identify edges in camera images, which are then processed similarly. In some advanced approaches, points are used to determine the position of lane markings or road boundaries relative to the vehicle. These points are directly output from a neural network, eliminating the need for additional engineering. Regardless of the technical approach, a set of dense edges or points on any lane boundary is considered accurate. These points can be mapped to a common polyline output format, where a set of points on the lane is output. The number of points in the polyline can be large, consuming significant bandwidth on vehicle data buses, especially in scenes with complex lane boundaries.

### SUMMARY

In general, this disclosure describes techniques for detecting lane and road boundaries. As described herein, a computing system may obtain a dense set of points corresponding to a lane boundary and may compute various lane boundary representations using a subset of these points. The computing system may then compare the representations to determine respective errors of the representations, and the number of points associated with each. The computing system may then select the representation that requires the fewest points. The computing system may output the selected lane boundary representation. The selected lane boundary representation may comprise a plurality of points and an indication of a curve prediction type associated with the selected lane boundary representation. This approach may reduce the data required for transmission on vehicle data buses, may enhance the efficiency of autonomous driving systems and other vehicle-related applications.

In one example, this disclosure describes a method for lane boundary estimation, the method comprising: obtaining, by one or more processors, a set of points corresponding to a lane boundary; computing, by the one or more processors, a plurality of lane boundary representations using at least a subset of the points, wherein each of the lane boundary representations maintains an accuracy to the lane boundary within a predetermined threshold; selecting, by the one or more processors, a lane boundary representation from the plurality of lane boundary representations that requires a smallest number of points; and outputting, by the one or more processors, the selected lane boundary representation.

In another example, this disclosure describes a system comprising: a memory configured to store a set of points corresponding to a lane boundary; and one or more processors configured to: compute a plurality of lane boundary representations using at least a subset of the points, wherein each of the lane boundary representations maintains an accuracy to the lane boundary within a predetermined threshold; select a lane boundary representation from the plurality of lane boundary representations that requires a smallest number of points; and output the selected lane boundary representation.

In another example, this disclosure describes one or more non-transitory computer-readable storage media having processor-executable instructions stored thereon that, when executed by one or more processors, cause the one or more processors to: obtain a set of points corresponding to a lane boundary; compute a plurality of lane boundary representations using at least a subset of the points, wherein each of the lane boundary representations maintains an accuracy to the lane boundary within a predetermined threshold; select a lane boundary representation from the plurality of lane boundary representations that requires a smallest number of points; and output the selected lane boundary representation.

The details of one or more examples are set forth in the accompanying drawings and the description below. Other features, objects, and advantages will be apparent from the description, drawings, and claims.

### BRIEF DESCRIPTION OF DRAWINGS

FIG. 1 shows an example vehicle 102 that may be configured to perform the perception tasks of this disclosure.

FIG. 2 is a block diagram illustrating an example device including a plurality of image sensors and an image signal processor according to techniques of this disclosure.

FIG. 3 is a conceptual diagram illustrating an example set of points corresponding to a lane boundary, in accordance with one or more techniques of this disclosure.

FIG. 4 is a conceptual diagram illustrating an example lane boundary representation along with an example set of points corresponding to a lane boundary, in accordance with one or more techniques of this disclosure.

FIG. 5 is a flowchart of an example operation in accordance with one or more techniques of this disclosure.

### DETAILED DESCRIPTION

Accurate lane and road boundary detection is an aspect of modern autonomous driving systems. Traditional approaches to lane boundary estimation often involve edge detection in images, followed by fitting the detected edges to a curve, such as a polynomial curve or a spline. More advanced methods use convolutional neural networks (CNNs) to identify edges in camera images, which are then processed similarly. These methods aim to provide precise information about the position of lane markings or road boundaries relative to the vehicle.

Despite the advancements in lane boundary detection, existing solutions face several challenges. Traditional edge detection methods can struggle with varying lighting conditions, occlusions, and complex road geometries, leading to inaccuracies. Modern approaches using CNNs, while more robust, still produce dense sets of points that require significant bandwidth for transmission on vehicle data buses. Additionally, these methods often output a large number of points, which can be computationally intensive to process and may not be necessary for accurate lane representation in all scenarios.

This disclosure presents techniques for reducing the number of points in lane boundary representations while maintaining accuracy. The techniques involve a computing system obtaining a relatively dense set of points corresponding to a lane boundary. The computing system may determine points in world coordinates or transformed from image coordinates. Additionally, the computing system may compute a plurality of different lane boundary representations using at least a subset of the points. The different lane boundary representations may be associated with different curve prediction types. The different curve prediction types may correspond to different ways of predicting a curve based on a set of points. Example curve prediction types may include linear interpolation, polynomial representations, and spline representations. A curve is a line that does not have to be straight. In other words, a curve may or may not be straight. The computing system may determine respective errors of the lane boundary representations and the number of points required for the lane boundary representations. The computing system may select the lane boundary representation that maintains accuracy within a specified threshold and requires the fewest number of points. If the number of points in two or more of the lane boundary representations is identical, the computing system may select the lane boundary representation with the least error. The computing system may output the selected lane boundary representation. The selected lane boundary representation may include data defining a curve corresponding to the lane boundary. For instance, the data defining the curve may indicate the curve prediction type associated with the selected lane boundary representation and data, such as spatial coordinates and coefficients, that may be used to determine a curve using the curve prediction type associated with the selected lane boundary representation.

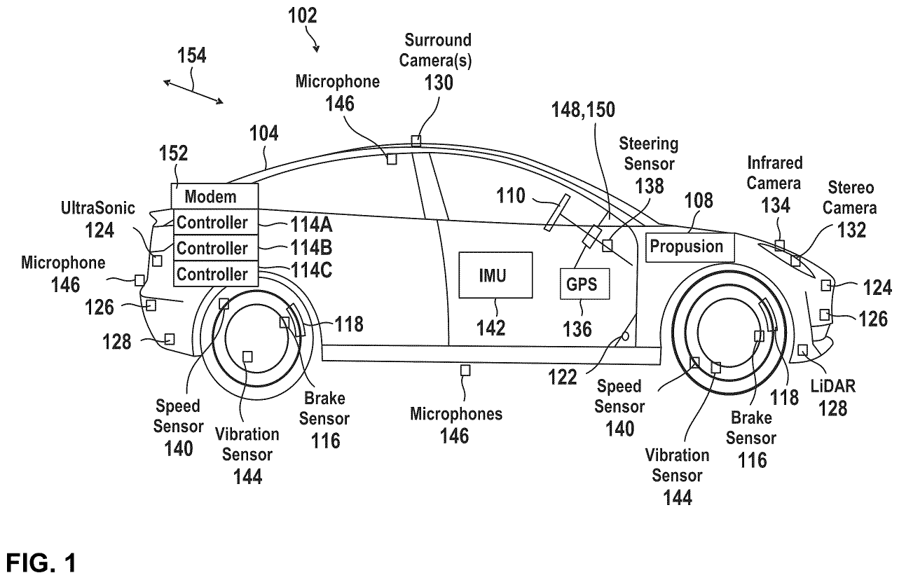

FIG. 1 shows an example vehicle 102 that may be configured to perform the perception tasks of this disclosure. Vehicle 102 in the example shown may comprise a passenger vehicle such as a car or truck that can accommodate a human driver and/or human passengers. In one example, vehicle 102 may comprise an autonomous vehicle or semi-autonomous vehicle. Vehicle 102 may include an ADAS. Vehicle 102 may include a vehicle body 104 coupled to a chassis, in this example comprised of four wheels and associated axles. A propulsion system 108 such as an internal combustion engine, hybrid electric power plant, or all-electric engine may be connected to drive some or all of the wheels via a drive train, which may include a transmission (not shown). A steering wheel 110 may be used to steer some or all of the wheels to direct vehicle 102 along a desired path when propulsion system 108 is operating and engaged to propel vehicle 102. Steering wheel 110 or the like may be optional for Level 5 implementations. One or more controllers 114A-114C (collectively, “controllers 114”) may provide autonomous capabilities in response to signals continuously provided in real-time from an array of sensors, as described more fully below.

Each of controllers 114 may be one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controllers 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In one example, an actuation controller may include dedicated hardware and software, allowing control of throttle, brake, steering, and shifting. The hardware may provide a bridge between the CAN bus of vehicle 102 and controllers 114, forwarding vehicle data to controllers 114 including the turn signal, wheel speed, acceleration, pitch, roll, yaw, Global Positioning System (“GPS”) data, tire pressure, fuel level, SONAR, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controllers 114 may provide autonomous driving outputs in response to an array of sensor inputs from the following sensors, including, for example: one or more ultrasonic sensors 124 (e.g., a SONAR sensor), one or more RADAR sensors 126, one or more LiDAR sensors 128, one or more surround cameras 130 (typically such cameras are located at various places on vehicle body 104 to image areas all around the vehicle body), one or more stereo cameras 132 (in one example, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controllers 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when controllers 114 have identified the presence of a stop sign, caution sign, or changing traffic light and is taking appropriate action, giving the vehicle occupants peace of mind that controllers 114 are functioning as intended. In one example, instrument cluster 148 may include a separate controller/processor configured to perform deep learning and artificial intelligence functionality.

Vehicle 102 may collect data that is preferably used to help train and refine the neural networks used for autonomous driving. Vehicle 102 may include a modem 152, preferably a system-on-a-chip that provides modulation and demodulation functionality and allows controllers 114 to communicate over wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

Vehicle 102 may include a plurality of cameras 130-134, capturing images around the entire periphery of vehicle 102. Camera type and lens selection depends on the nature and type of function. Vehicle 102 may have a mix of camera types and lenses to provide complete coverage around vehicle 102; in general, narrow lenses do not have a wide field of view but can see farther. All camera locations on the vehicle 102 may support interfaces such as Gigabit Multimedia Serial link (GMSL) and Gigabit Ethernet.

As was described above, vehicle 102 preferably is configured with sensors that provide access to a 360-degree surround representation of the environment for safe and efficient navigation. A multi-camera sensor and depth sensor system may be configured to reliably capture a complete surrounding representation around vehicle 102 by aggregating pixel level information from cameras 130-134 with depth, geometry, and/or velocity information from a depth sensor. The techniques of this disclosure are applicable for use with any type of depth sensor, including ultrasonic sensors 124, RADAR sensors 126, LiDAR sensors 128, and stereo cameras 132. In addition, though not shown in FIG. 1, other example depth sensors may be used in conjunction with the techniques of this disclosure, including infrared depth sensors, structured light sensors, and/or time-of-flight (ToF) camera sensors.

In some example perception models, 3D depth data from a depth sensor (e.g., a RADAR point cloud) is processed by a depth feature extractor to obtain depth feature vectors. The 3D depth features vectors may then be flattened into a birds-eye-view (BEV) representation. Additionally, one or more camera images captured at approximately the same time as the 3D depth data may be processed by a camera feature extractor to obtain camera feature vectors. These camera feature vectors may be processed by a view transformation to convert the camera features from perspective views into the same BEV representation as the depth feature vectors. One example of a view transformation is lift, shoot, splat. As part of the lift, shoot, splat process, implicit depth estimation is performed for each of the camera feature vectors. A BEV representation in computer vision refers to a top-down perspective of a scene, as if viewed from above, similar to the perspective of a bird flying overhead. A BEV representation is particularly valuable in applications such as autonomous driving, robotics, and surveillance, where understanding the spatial layout and relationships between objects on the ground plane is beneficial. In the context of computer vision, generating a BEV representation involves transforming image data from one or more cameras into a top-down view. This top-down perspective simplifies various tasks in computer vision, such as object detection, tracking, and path planning, by reducing the complexity of the scene and offering a more intuitive understanding of spatial relationships. Additionally, as discussed above, BEV representations are often integrated with data from other sensors, such as LiDAR or RADAR, to enhance accuracy and robustness in dynamic and complex environments.

After transformation to the BEV representation, the depth feature vectors and the camera feature vectors may be fused into BEV feature vectors. One or more perception tasks, such as 3D object detection, lane detection, object tracking and segmentation tasks, may then be performed on the BEV feature vectors. The general perception model described above may be trained to learn an implicit depth representation for each pixel in the perspective view to transform features from perspective view to the BEV representation.

Controllers 114 may receive data from the sensors of vehicle 102 (e.g., ultrasonic sensors 124, RADAR sensors 126, LiDAR sensors 128, stereo cameras 132, etc.) and use the data to generate points corresponding to lane boundaries. Controllers 114 may use the points to determine lane boundaries. Traditional methods for determining lane boundaries, such as edge detection methods, can struggle with varying lighting conditions, occlusions, and complex road geometries, leading to inaccuracies. Approaches for determining lane boundaries that use CNNs may be more robust but may still produce dense sets of points that require significant bandwidth for transmission on vehicle data buses. Additionally, these methods often output a large number of points, which can be computationally intensive to process and may not be necessary for accurate lane representation in all scenarios.

This disclosure presents techniques for reducing the number of points in lane boundary representations while maintaining accuracy. The techniques involve controllers 114 obtaining a relatively dense set of points corresponding to a lane boundary. Controllers 114 may determine points in world coordinates or transformed from image coordinates. Additionally, controllers 114 may compute a plurality of different lane boundary representations using at least a subset of the points. The different lane boundary representations may be associated with different curve prediction types. The different curve prediction types may correspond to different ways of predicting a curve based on a set of points. Example curve prediction types may include linear interpolation, polynomial representations, and spline representations. A curve is a line that does not have to be straight. In other words, a curve may or may not be straight. Controllers 114 may determine respective errors of the lane boundary representations and the number of points required for the lane boundary representations. Controllers 114 may select the lane boundary representation that maintains accuracy within a specified threshold and requires the fewest number of points. The selected lane boundary representation may include data defining a curve corresponding to the lane boundary. Controllers 114 may use the selected lane boundary representation for various purposes, such as controlling operation of vehicle 102.

Although in the example of FIG. 1, vehicle 102 is shown as a car, vehicle 102 may be other types of vehicles. For example, vehicle 102 may be a truck, recreational vehicle, boat, ship, aircraft, or other type of vehicle.

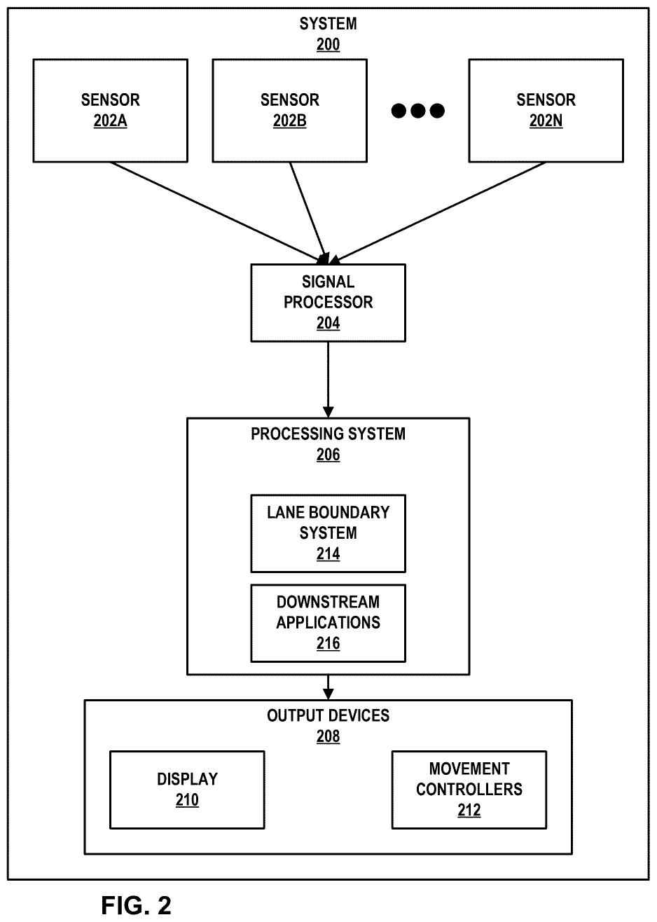

FIG. 2 is a block diagram illustrating an example system 200 that includes a plurality of sensors 202A-202N (collectively, “sensors 202”), a signal processor (SP) 204, a processing system 206, and one or more output devices 208. In various examples, system 200 may be part of a vehicle (e.g., vehicle 102), a smartphone, a mobile device, a computing device, a robot, or other type of device.

Sensors 202 are configured to generate sensor data, such as optical video data, depth image data, night-vision image data, and so on. Sensors 202 may include one or more of ultrasonic sensors 124, one or more LiDAR sensors 128, surround cameras 130, more stereo cameras 132, one or more infrared cameras 134. Sensors 202 may include cameras or other types of sensors that generate sensor data. Sensors 202 may be positioned at various locations around system 200. For instance, in an example where system 200 is a vehicle, sensors 202 may include one or more forward-facing image sensors, one or more rear-facing image sensors, one or more left-side image sensors, one or more right-side image sensors, trailer image sensors, underbody image sensors, cargo bed image sensors, and so on.

The sensor data generated by sensors 202 may have different characteristics. For example, individual sensors 202 may generate sensor data having different height and width sizes, different color bit depths, different pixel sizes, different color-coding schemes (e.g., Red-Green-Blue, CyBC, etc.), and so on. There may be different numbers of sensors 202 in different systems and the sensor data generated by sensors 202 within those systems may have different characteristics.

SP 204 may comprise a discrete hardware unit within system 200. For example, SP 204 may be a modular, self-contained unit of hardware within system 200. In different examples, SP 204 may or may not be connected to a motherboard shared with processing system 206. A role of SP 204 is to preprocess sensor data generated by sensors 202 prior to use of the sensor data by processing system 206. Examples of preprocessing the sensor data may include harmonizing characteristics of sensor data across sensors 202, synchronizing sensor data, regularizing illumination levels across sensors 202, correcting for lens distortion, increase gain at corners of images, and other tasks that ready the sensor data for use by processing system 206. SP 204 may be part of a larger pipeline for processing sensor data. Controller 114 may include one or more of SP 204 and processing system 106.

Processing system 206 may include one or more processing units (i.e., processors). In some examples, processing system 206 may include a pipeline of processors. Processing system 206 may obtain sensor data that has been preprocessed by SP 204. Processing system 206 may use the sensor data for one or more purposes. In some examples, processing system 206 may apply one or more filters to the sensor data. In an example where system 200 is a vehicle or robot, processing system 206 may use the sensor data for navigation. In an example where system 200 is a smartphone, processing system 206 may use the sensor data to produced images for human consumption.

Processing system 206 may cause output devices 208 to produce various types of output. For instance, in the example of FIG. 2, output devices 208 include a display 210. Processing system 206 may cause display 210 to display images and/or video based on the sensor data generated by one or more of sensors 202. Additionally, in the example of FIG. 2, output devices 208 may include one or more movement controllers 212. Movement controllers 212 may perform actions to move system 200. For instance, in examples system 200 is a vehicle, movement controllers 212 may steer, accelerate, or brake the vehicle. In an example where system 200 is a robot, movement controllers 212 may cause different portions of the robot to move in particular ways. It is to be understood that display 210 and movement controllers 212 are provided in FIG. 2 as examples of output devices 208 and not all examples include either or both display 210 and movement controllers 212, and that output devices 208 may include other types of devices and systems.

Processing system 206 and the various components of SP 204 may be implemented as any of a variety of suitable circuitry components, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure.

In the example of FIG. 2, processing system 206 implements a lane boundary system 214 and one or more downstream applications 216. In some examples, one or more processors of processing system 206 execute instructions that cause the one or more processors to implement processing system 206 and/or downstream applications 216. In some examples, processing system 206 includes one or more application-specific integrated circuits that at least partially implement lane boundary system 214 and/or downstream applications 216.

In accordance with one or more techniques of this disclosure, lane boundary system 214 may obtain a set of points corresponding to a lane boundary. For instance, lane boundary system 214 may generate the set of points based on sensor data generated by one or more of sensors 202. Signal processor 204 may process the sensor data prior to lane boundary system 214 generating the set of points. A lane boundary be an edge of a marked lane of traffic, such as a solid or dashed line painted or otherwise marked on a surface that is traveled upon, such as a roadway or floor. A lane boundary may also be an edge of a roadway or other surface that is traveled upon. For instance, lane boundaries may occur where pavement ends and an unpaved surface begins. Lane boundaries may occur on roadways, airports, seaports, factories, warehouses, distribution centers, parking lots, and so on.

Lane boundary system 214 may compute a plurality of lane boundary representations using at least a subset of the points. That is, lane boundary system 214 may compute each of the plurality of lane boundary representation using some or all of the points. In some examples, each of the lane boundary representations may maintain an accuracy to the lane boundary within a predetermined threshold. Lane boundary system 214 may select a lane boundary representation from the plurality of lane boundary representations that requires a smallest number of points. In some examples, lane boundary system 214 may select the lane boundary representation from the plurality of lane boundary representations that require the smallest number of points while also maintaining accuracy within a predetermined threshold.

In some examples, the predetermined threshold may be measured in units that are dependent on metrics used for determining accuracy. For instance, if the accuracy is determined in terms of mean-squared error (MSE), then the units of the predetermined threshold may be one of length squared, e.g. m² or square feet. If instead the accuracy is determined in terms of root mean square error (RMSE), then the units of the predetermined threshold may be one of length, e.g. meters or feet. In some such examples, the predetermined threshold may be 15 centimeters (cm), which may guarantee that the representation would use at maximum lane boundary representations that deviate from the “true” lane boundary by at most 15 cm at any given point.

Lane boundary system 214 may output the selected lane boundary representation. For instance, lane boundary system 214 may output the selected lane boundary representation to one or more of downstream applications 216. Downstream applications 216 may use the selected lane boundary representation in various ways to enhance the functionality and performance of autonomous driving systems and other vehicle-related applications. Because the selected lane boundary representation may be the most more concise representation of the lane boundary that maintains the accuracy within the predetermined threshold, the amount of bandwidth required to output a representation of the lane boundary may be reduced on vehicle buses, which may be a constrained resource. At the same time, the selected lane boundary representation may maintain sufficient accuracy for drive policy applications.

In some examples, downstream applications 216 may use the lane boundary representation to assist in autonomous navigation. For instance, one or more of downstream applications 216 may provide instructions to movement controllers 212 to control movement of system 200. By accurately representing the lane boundaries, a control system of system 200 (e.g., a vehicle, robot, etc.) can make informed decisions about steering, lane keeping, and lane changes, ensuring safe and efficient navigation. In some examples, downstream applications 216 may use the selected lane boundary representation in advanced driver assistance systems (ADAS). ADAS can use the lane boundary representation to provide features such as lane departure warnings, lane keeping assistance, and adaptive cruise control. ADAS can use the accurate lane boundary information to alert the driver or take corrective actions to maintain the vehicle within the lane. In some examples, the same one or more processors that provide lane boundary system 214 provide one or more of downstream applications 216 (e.g., ADAS). In some examples, the processors of processing system 206 includes one or more first processors that provide lane boundary system 214 and one or more second processors distinct from the one or more first processors that provide one or more of downstream applications 216 (e.g., ADAS).

In some examples, downstream applications 216 may use the lane boundary representation for path planning algorithms. By understanding the precise layout of the lanes, the vehicle can plan optimal paths for various driving scenarios, such as merging onto highways, navigating intersections, and avoiding obstacles. In some examples, a robot may navigate a facility (e.g., a warehouse, factory, airport, seaport, logistics hub, etc.) that has marked lanes. Downstream applications 216 may use the lane boundary representation to ensure that the robot stays within the lanes while avoiding obstacles. Ensuring that the robot stays within the lanes may help to ensure worker safety.

In some examples, downstream applications 216 may use the lane boundary representation in conjunction with traffic sign and signal recognition systems. By knowing the exact position of the lanes, the vehicle can better interpret and respond to traffic signs and signals, improving overall situational awareness and compliance with traffic rules. In some examples, downstream applications 216 may share the lane boundary representation with other vehicles and infrastructure through V2V and V2I communication systems. The lane boundary representation can enhance cooperative driving strategies, such as platooning, and improve traffic flow and safety by providing a common understanding of the road layout. In the example of robots navigating a facility, the robots may share the lane boundary representations as well as information about obstacles in the lanes so that routes to be taken by the robots may be planned. In some examples, downstream applications 216 may use the lane boundary representation to update and refine digital maps. Accurate lane boundary information can improve the vehicle's localization capabilities, allowing it to determine its precise position on the road and navigate more effectively. In some examples, downstream applications 216 may use the lane boundary representation in simulation and testing environments to validate and improve autonomous driving algorithms. By simulating various driving scenarios with accurate lane boundaries, developers can test and refine their systems to ensure robust performance in real-world conditions.

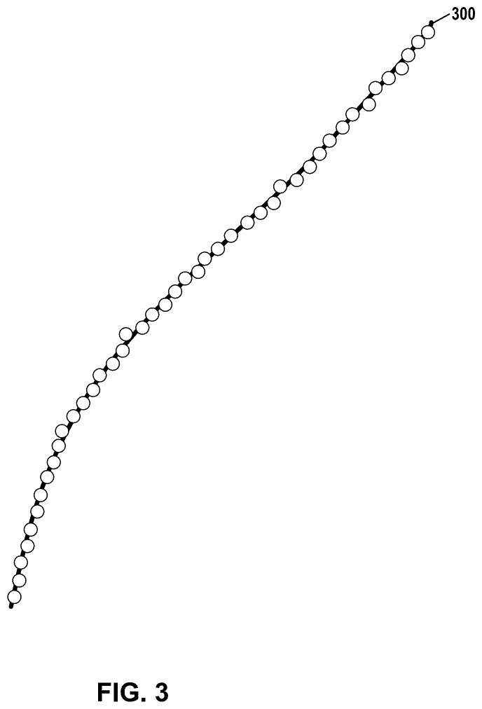

FIG. 3 is a conceptual diagram illustrating an example set of points corresponding to a lane boundary 300. The points are represented by circles and describe the lane boundary. These points are distributed along lane boundary 300, providing a detailed representation of the lane's curvature. The set of points may serve as the input for a lane boundary estimation process performed by lane boundary system 214, where lane boundary system 214 computes different lane boundary representations using at least a subset of the points to reduce the output size.

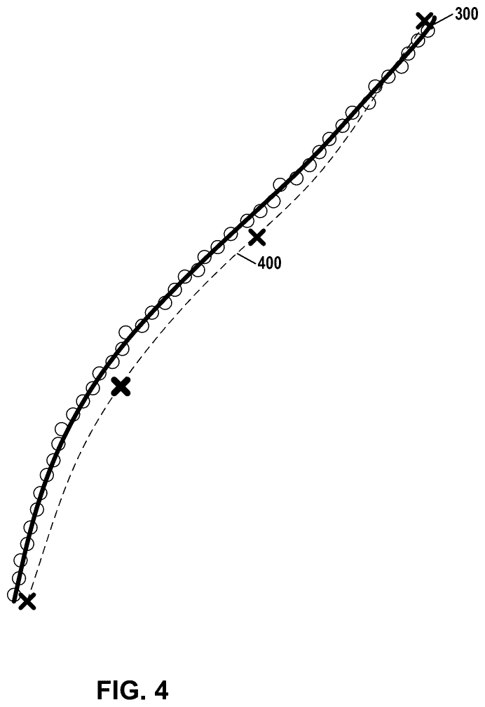

FIG. 4 is a conceptual diagram illustrating an example lane boundary representation 400 along with an example set of points corresponding to lane boundary 300, in accordance with one or more techniques of this disclosure. In the example of FIG. 4, the points are represented by circles and describe the lane boundary. The solid line represents the actual lane boundary 300, while the dashed line represents the selected lane boundary representation 400 computed using at least a subset of the points. Lane boundary system 214 may select this lane boundary representation 400 from among a plurality of lane boundary representations to reduce the output size. FIG. 4 demonstrates how the selected lane boundary representation 400 may approximate the actual lane boundary 300 using at least a subset of the points, thereby reducing the data required for transmission on vehicle data buses. In the example of FIG. 4, “X” marks indicate the points specified by the selected lane boundary representation. Note that the points included in the selected lane boundary representation may not be the same as the points that lane boundary system 214 initially obtained.

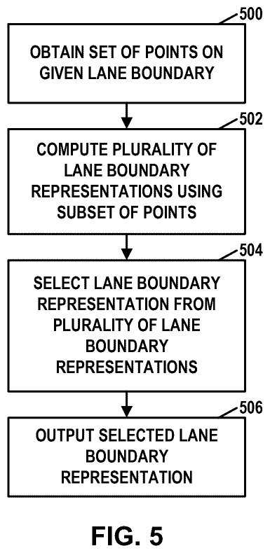

FIG. 5 is a flowchart illustrating an example operation in accordance with one or more techniques of this disclosure. In the example of FIG. 5, lane boundary system 214 may obtain a set of points corresponding to a lane boundary (500). These points describe the lane boundary. The points may be associated with 3-dimensional coordinates, such as (x, y, z) coordinates or spherical coordinates.

Lane boundary system 214 may obtain the points through various methods, depending on the specific implementation and available technology. For example, lane boundary system 214 may use a neural network, such as a convolutional neural network (CNN), trained to generate points corresponding to edges of lane markings or road boundaries based on images. The images may be generated by one or more of sensors 202. The neural network may output a set of points that describe the lane boundary with high accuracy. These points can be predicted either in world coordinates directly or in image coordinates, which are then transformed to world coordinates using an estimation of the road profile ahead.

In some examples, lane boundary system 214 may employ classical methods to obtain the points. These classical methods typically involve edge detection algorithms applied to the camera images to identify the edges of lane markings or road boundaries. The detected edges are then fitted to a curve, such as a polynomial or spline, to generate a dense set of points. In both approaches, lane boundary system 214 may ensure that the points are distributed along the lane boundary, providing a detailed representation of the lane's curvature.

Lane boundary system 214 may compute a plurality of lane boundary representations using at least a subset of the points (502). The lane boundary representations may be associated with different curve prediction types. The different curve prediction types may include linear interpolation, polynomial representations, and spline representations. The different curve prediction types may correspond to different ways of predicting a curve based on a set of points. Lane boundary system 214 may compute the plurality of lane boundary representations using at least a subset of the points obtained.

In some examples, lane boundary system 214 may compute a lane boundary representation using linear interpolation. Lane boundary system 214 may compute a linear interpolation representation by selecting a subset of the points and connecting them with straight lines. This approach may be particularly useful for representing very irregular road boundaries or piecewise linear lane markings. In such examples, the lane boundary representation may include coordinates of a starting point of a line, and a coefficient corresponding to a slope of the line.

In some examples, lane boundary system 214 may compute a lane boundary representation using a polynomial representation. Lane boundary system 214 may compute polynomial representations, such as quadratic or cubic polynomials, by fitting a polynomial curve to a subset of the points. Lane boundary system 214 may determine the coefficients of the polynomial in such a way that the curve closely approximates the lane boundary within a specified accuracy threshold. For example, lane boundary system 214 may compute a cubic representation of a lane marking using the polynomial y(x)=c₀+c₁x+c₂x²+c₃x³. This polynomial may be represented by its coefficients (c₀, c₁, c₂, and c₃) and four arbitrary points along the curve. In such examples, the lane boundary representation may include the coefficients and coordinates of the points along the curve.

In some examples, lane boundary system 214 may compute a lane boundary representation using a spline representation. Lane boundary system 214 may compute spline representations, such as B-splines or cubic splines, by fitting a spline curve to a subset of the points. Splines are piecewise polynomial functions that provide a smooth and continuous representation of the lane boundary, maintaining accuracy within the specified threshold. In such examples, the lane boundary representation may include coordinates of control points, coordinates of knots, polynomial coefficients, data indicating the degrees of polynomials, and so on.

In some examples, for each potential lane boundary representation, lane boundary system 214 calculates the accuracy of the representation by measuring the error between the computed representation and the points originally obtained. Common metrics for measuring accuracy include Mean Square Error (MSE) and maximum error. Lane boundary system 214 may then determine which lane boundary representations maintain accuracy within the predetermined threshold. Lane boundary system 214 may compare the respective errors of the lane boundary representations and the number of points required for each representation. This may allow lane boundary system 214 to select the most efficient representation that reduces the output size while, in some examples, maintaining the required accuracy.

Lane boundary system 214 may then select, from among the plurality of lane boundary representations, the lane boundary representation that requires the smallest number of points (504). As mentioned elsewhere in this disclosure, a lane boundary representation, a lane boundary representation may include data defining a curve corresponding to the lane boundary. The data defining the curve may indicate the curve prediction type associated with the lane boundary representation and data, such as spatial coordinates (i.e., points) and coefficients, that may be used to determine a curve using the curve prediction type associated with the lane boundary representation. Less complex lane boundary representations may specify fewer points than more complex lane boundary representations. For instance, a lane boundary representation associated with a linear interpolation prediction type may specify fewer points than a lane boundary representation associated with a spline-based prediction type.

In some examples, lane boundary system 214 selects the lane boundary representation that requires the smallest number of points while maintaining accuracy within a specified threshold. In some examples, where two or more representations have identical point counts, lane boundary system 214 selects the representation with the smallest error among those with identical point counts.

Lane boundary system 214 may output the selected lane boundary representation (506). The selected lane boundary representation may include data defining a curve corresponding to the lane boundary. For instance, the data defining the curve may indicate the curve prediction type associated with the selected lane boundary representation and data, such as spatial coordinates and coefficients, that may be used to determine a curve using the curve prediction type associated with the selected lane boundary representation. In some examples, lane boundary system 214 may output the lane boundary representation in a polyline format. In some examples, lane boundary system 214 may output the lane boundary representation to a polyline interface (e.g., an application programming interface configured to receive information in a polyline format).

One or more of downstream applications 115 may use the indicated curve prediction type for estimating points between or beyond the output points. In other words, one or more of downstream applications 115 may interpolate or extrapolate one or more additional points of the lane boundary using the curve prediction type and the plurality of points indicated by the selected lane boundary representation. For example, the selected lane boundary representation may include a point at a distance of 5 meters and a point at a distance of 10 meters. In this example, a downstream application may use the indicated curve prediction type and the points of the selected lane boundary representation to interpolate a position of a point at a distance of 7.5 meters. Thus, it may be unnecessary for lane boundary system 214 to output a large number of points or a very detailed representation of the lane boundary. In this way, the techniques of this disclosure may reduce the amount of data required for transmission on vehicle data buses while maintaining sufficient accuracy for drive policy applications.

Various examples of the techniques of this disclosure are summarized in the following clauses:

Clause 1. A method for lane boundary estimation, the method comprising: obtaining, by one or more processors, a set of points corresponding to a lane boundary; computing, by the one or more processors, a plurality of lane boundary representations using at least a subset of the points; selecting, by the one or more processors, from among the plurality of lane boundary representations, a lane boundary representation that requires a smallest number of points; and outputting, by the one or more processors, the selected lane boundary representation.

Clause 2. The method of clause 1, wherein the plurality of lane boundary representations are associated with one or more of: a linear interpolation, a polynomial representation, or a spline representation.

Clause 3. The method of any of clauses 1-2, wherein selecting the lane boundary representation comprises based on there being two or more of the lane boundary representations that have identical point counts, selecting, by the one or more processors, the lane boundary representation with a smallest error among the two or more of the lane boundary representations that have identical point counts.

Clause 4. The method of any of clauses 1-3, wherein the selected lane boundary representation comprises a plurality of points and an indication of a curve prediction type associated with the selected lane boundary representation.

Clause 5. The method of clause 4, further comprising: interpolating or extrapolating one or more additional points of the lane boundary using an interpolation method associated with the curve prediction type and the plurality of points indicated by the selected lane boundary representation.

Clause 6. The method of any of clauses 1-5, wherein selecting the lane boundary representation comprises selecting the lane boundary representation that requires the smallest number of points while maintaining accuracy within a predetermined threshold.

Clause 7. The method of clause 6, wherein computing the plurality of lane boundary representations comprises: for each potential lane boundary representation of a plurality of potential lane boundary representations: computing the potential lane boundary based on the points; calculating the accuracy of the potential lane boundary representation as one of a mean square error (MSE) or a maximum error; and determining the lane boundary representations has those potential lane boundary representations that have accuracies within the predetermined threshold.

Clause 8. The method of any of clauses 1-7, further comprising using, by the one or more processors, the selected lane boundary representation to make a decision about one or more of steering, lane keeping, or lane changes.

Clause 9. A system comprising: a memory configured to store a set of points corresponding to a lane boundary; and one or more processors configured to: compute a plurality of lane boundary representations using at least a subset of the points; select a lane boundary representation from the plurality of lane boundary representations that requires a smallest number of points; and output the selected lane boundary representation.

Clause 10. The system of clause 9, wherein the plurality of lane boundary representations are associated with one or more of: a linear interpolation, a polynomial representation, or a spline representation.

Clause 11. The system of any of clauses 9-10, wherein the one or more processors are further configured to, based on there being two or more of the lane boundary representations that have identical point counts, select the lane boundary representation with a smallest error among the two or more of the lane boundary representations that have identical point counts.

Clause 12. The system of any of clauses 9-11, wherein the selected lane boundary representation comprises a plurality of points and an indication of a curve prediction type associated with the selected lane boundary representation.

Clause 13. The system of clause 12, wherein the one or more processors are further configured to interpolate or extrapolate one or more additional points of the lane boundary using an interpolation method associated with the curve prediction type and the plurality of points indicated by the selected lane boundary representation.

Clause 14. The system of any of clauses 9-13, wherein the one or more processors are configured to select the lane boundary representation that requires the smallest number of points while maintaining accuracy within a predetermined threshold.

Clause 15. The system of clause 14, wherein the one or more processors are further configured to, for each potential lane boundary representation of a plurality of potential lane boundary representations: compute the potential lane boundary based on the points; calculate the accuracy of the potential lane boundary representation as one of a mean square error (MSE) or a maximum error; and determine the lane boundary representations as those potential lane boundary representations that have accuracies within the predetermined threshold.

Clause 16. The system of any of clauses 9-15, wherein the one or more processors are further configured to use the selected lane boundary representation to make a decision about one or more of steering, lane keeping, or lane changes.

Clause 17. The system of any of clauses 9-16, wherein the one or more processors are further configured to use the selected lane boundary representation to assist in autonomous navigation by making informed decisions about steering, lane keeping, and lane changes.

Clause 18. The system of any of clauses 9-17, wherein the one or more processors are further configured to use the selected lane boundary representation in advanced driver assistance systems (ADAS) to provide features such as lane departure warnings, lane keeping assistance, and adaptive cruise control.

Clause 19. One or more non-transitory computer-readable storage media having processor-executable instructions stored thereon that, when executed by one or more processors, cause the one or more processors to: obtain a set of points corresponding to a lane boundary; compute a plurality of lane boundary representations using at least a subset of the points; select a lane boundary representation from the plurality of lane boundary representations that requires a smallest number of points; and output the selected lane boundary representation.

Clause 20. The one or more non-transitory computer-readable storage media of clause 19, wherein the instructions that cause the one or more processors to select the lane boundary representation comprise instructions that, when executed by the one or more processors, cause the one or more processors to, based on there being two or more of the lane boundary representations that have identical point counts, select the lane boundary representation with a smallest error among the two or more of the lane boundary representations that have identical point counts.

Clause 21. The one or more non-transitory computer-readable storage media of any of clauses 19-20, wherein the selected lane boundary representation comprises a plurality of points and an indication of a curve prediction type associated with the selected lane boundary representation.

Clause 22. The one or more non-transitory computer-readable storage media of any of clauses 19-21, wherein the instructions that cause the one or more processors to compute the plurality of lane boundary representations comprise instructions that, when executed by the one or more processors, cause the one or more processors to, for each potential lane boundary representation of a plurality of potential lane boundary representations: compute the potential lane boundary based on the points; calculate the accuracy of the potential lane boundary representation as one of a mean square error (MSE) or a maximum error; and determine the lane boundary representations has those potential lane boundary representations that have accuracies within a predetermined threshold.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method for lane boundary estimation, the method comprising:
obtaining, by one or more processors, a set of points corresponding to a lane boundary;
computing, by the one or more processors, a plurality of lane boundary representations using at least a subset of the points;
selecting, by the one or more processors, from among the plurality of lane boundary representations, a lane boundary representation that requires a smallest number of points; and
outputting, by the one or more processors, the selected lane boundary representation.

2. The method of claim 1, wherein the plurality of lane boundary representations are associated with one or more of: a linear interpolation, a polynomial representation, or a spline representation.

3. The method of claim 1, wherein selecting the lane boundary representation comprises based on there being two or more of the lane boundary representations that have identical point counts, selecting, by the one or more processors, the lane boundary representation with a smallest error among the two or more of the lane boundary representations that have identical point counts.

4. The method of claim 1, wherein the selected lane boundary representation comprises a plurality of points and an indication of a curve prediction type associated with the selected lane boundary representation.

5. The method of claim 4, further comprising: interpolating or extrapolating one or more additional points of the lane boundary using an interpolation method associated with the curve prediction type and the plurality of points indicated by the selected lane boundary representation.

6. The method of claim 1, wherein selecting the lane boundary representation comprises selecting the lane boundary representation that requires the smallest number of points while maintaining accuracy within a predetermined threshold.

7. The method of claim 6, wherein computing the plurality of lane boundary representations comprises: for each potential lane boundary representation of a plurality of potential lane boundary representations:
computing the potential lane boundary based on the points;
calculating the accuracy of the potential lane boundary representation as one of a mean square error (MSE) or a maximum error; and
determining the lane boundary representations has those potential lane boundary representations that have accuracies within the predetermined threshold.

8. The method of claim 1, further comprising using, by the one or more processors, the selected lane boundary representation to make a decision about one or more of steering, lane keeping, or lane changes.

9. A system comprising:
a memory configured to store a set of points corresponding to a lane boundary; and
one or more processors configured to:
compute a plurality of lane boundary representations using at least a subset of the points;
select a lane boundary representation from the plurality of lane boundary representations that requires a smallest number of points; and
output the selected lane boundary representation.

10. The system of claim 9, wherein the plurality of lane boundary representations are associated with one or more of: a linear interpolation, a polynomial representation, or a spline representation.

11. The system of claim 9, wherein the one or more processors are further configured to, based on there being two or more of the lane boundary representations that have identical point counts, select the lane boundary representation with a smallest error among the two or more of the lane boundary representations that have identical point counts.

12. The system of claim 9, wherein the selected lane boundary representation comprises a plurality of points and an indication of a curve prediction type associated with the selected lane boundary representation.

13. The system of claim 12, wherein the one or more processors are further configured to interpolate or extrapolate one or more additional points of the lane boundary using an interpolation method associated with the curve prediction type and the plurality of points indicated by the selected lane boundary representation.

14. The system of claim 9, wherein the one or more processors are configured to select the lane boundary representation that requires the smallest number of points while maintaining accuracy within a predetermined threshold.

15. The system of claim 14, wherein the one or more processors are further configured to, for each potential lane boundary representation of a plurality of potential lane boundary representations:
compute the potential lane boundary based on the points;
calculate the accuracy of the potential lane boundary representation as one of a mean square error (MSE) or a maximum error; and
determine the lane boundary representations as those potential lane boundary representations that have accuracies within the predetermined threshold.

16. The system of claim 9, wherein the one or more processors are further configured to use the selected lane boundary representation to make a decision about one or more of steering, lane keeping, or lane changes.

17. The system of claim 9, wherein the one or more processors are further configured to use the selected lane boundary representation to assist in autonomous navigation by making informed decisions about steering, lane keeping, and lane changes.

18. The system of claim 9, wherein the one or more processors are further configured to use the selected lane boundary representation in advanced driver assistance systems (ADAS) to provide features such as lane departure warnings, lane keeping assistance, and adaptive cruise control.

19. One or more non-transitory computer-readable storage media having processor-executable instructions stored thereon that, when executed by one or more processors, cause the one or more processors to:
obtain a set of points corresponding to a lane boundary;
compute a plurality of lane boundary representations using at least a subset of the points;
select a lane boundary representation from the plurality of lane boundary representations that requires a smallest number of points; and
output the selected lane boundary representation.

20. The one or more non-transitory computer-readable storage media of claim 19, wherein the instructions that cause the one or more processors to select the lane boundary representation comprise instructions that, when executed by the one or more processors, cause the one or more processors to, based on there being two or more of the lane boundary representations that have identical point counts, select the lane boundary representation with a smallest error among the two or more of the lane boundary representations that have identical point counts.
